(19) United States
(12) Patent Application Publication
(10) Pub. No.: US 2003/0011838 A1
(43) Pub. Date: Jan. 16, 2003

(54) Multiplexed optical transition method and multiplexed optical transmitter

(76) Inventors: Akira Sasaki, Tokyo (JP); Masayuki Kashima, Tokyo (JP); Naoki Minato, Tokyo (JP)

Correspondence Address: RABIN & CHAMPAGNE, PC, 1101 14TH STREET, NW, SUITE 500, WASHINGTON, DC, 20005, US

(21) Appl. No.: 10/173,125

(22) Filed: Jun. 18, 2002

(30) Foreign Application Priority Data
Jun. 18, 2001 (JP) 183419/2001

(51) Int. Cl. H04J 14/00

(52) U.S. Cl. 359/115

(57) ABSTRACT

A multiplexed optical transmitter according to this invention comprises first spreader which code-spreads first data stream of electrical signal by first spreading-code, first frequency-converter which converts a frequency of the code-spread first data stream into first frequency, and first electrical-optical converter which converts the first data stream into first optical carrier of first optical signal having a predetermined optical wavelength. Furthermore, the multiplexed optical transmitter comprises second spreader which code-spreads second data stream of electrical signal by second spreading-code, second frequency-converter which converts a frequency of the code-spread second data stream into second frequency, and second electrical-optical converter which converts the second data stream into second optical carrier of second optical signal having the predetermined optical wavelength. Then, an optical coupler couples the first optical signal and the second optical signal for generating a multiplexed optical signal having the first optical carrier and the second optical carrier.

### BACKGROUND OF THE INVENTION

The present invention relates to an optical transmission method and an optical transmitter which use code-division multiplexing and optical carrier multiplexing.

Conventionally, in order to realizing large-scale transmission, optical transmitters using both of the time-division multiplexing and the wavelength-division multiplexing, or using the optical sub-carrier multiplexing, which superimposes many data signals into optical carriers, are proposed.

FIG. 2 shows a schematic diagram of a conventional multiplexed optical transmission system using both of the time-division multiplexing and the wavelength-division multiplexing.

In the FIG. 2, each of Data_{—1}, . . . , Data_{—M} is a data stream which is time-division multiplexed, and inputted into optical transmitters (:TX) 210_{—1}, . . . , 210_{—M} at the transmitter side, respectively.

The optical transmitters 210_{—1}, . . . , 210_{—M} have different oscillation wavelengths λ₁, . . . , λ_{M}, and they output optical signals modulated based on the inputted data streams Data_{—1}, . . . , Data_{—M} respectively.

The modulated optical signals outputted from the optical transmitter 210_{—1}, . . . , 210_{—M} and having different wavelengths each other, are coupled by a coupler (:MUX) 220. Consequently, a wavelength-division multiplexed optical signal is generated and transmitted to the receiver side via optical fiber transmission lines (:fiber) 230.

At the receiver side, the wavelength-division multiplexed optical signal is separated into elements of wavelengths λ₁, . . . , λ_{M} by a de-mixer (:DE-MUX)240, and the elements are inputted into optical receivers (:RX) 250_{—1}, . . . , 250_{—M} respectively.

At the optical receivers 250_{—1}, . . . , 250_{—M}, the data streams Data_{—1}, . . . , Data_{—M} are reproduced form the inputted elements, respectively.

Also in the case of optical sub-carrier multiplexing, optical transmitters for the optical sub-carrier multiplexing differs from the transmitters of the FIG. 2 in that the transmitters for the optical sub-carrier multiplexing superimposes data into optical carriers of optical signals. However, the transmitters for the optical sub-carrier multiplexing and the transmitters of the FIG. 2 overlap about the systems use plural optical transmitters having different oscillation wavelengths each other and using a coupler for wavelength-division multiplexing.

In the case of the above-mentioned conventional transmission systems, when oscillation wavelengths (:optical frequencies) λ₁, . . . , λ_{M} of the optical transmitters 210_{—1}, . . . , 210_{—M} are approximated or accorded each other, interference between the signals cause beat noises deteriorating transmission quality of the systems.

Then, in order to keep the transmission quality, the conventional optical transmitters need some components having wavelength stabilizing function and wavelength supervisory function. And the components cause increasing of the optical transmitter cost.

Furthermore, in order to prevent the interference, the transmitters of the systems can't have narrow separations between the oscillation wavelengths.

Thus the conventional systems restrict a number of signal wavelengths a regular capacity, or arrangements of selectable signal wavelengths.

### SUMMARY OF THE INVENTION

In view of the foregoing, an object of the present invention is to realize a multiplexed optical transition system for large-scale transmission without increasing of optical transmitters cost.

A multiplexed optical transmitter according to this invention comprises first spreader which code-spreads first data stream of electrical signal by first spreading-code, first frequency-converter which converts a frequency of the code-spread first data stream into first frequency, and first electrical-optical converter which converts the first data stream into first optical carrier of first optical signal having a predetermined optical wavelength.

Furthermore, the multiplexed optical transmitter comprises second spreader which code-spreads second data stream of electrical signal by second spreading-code, second frequency-converter which converts a frequency of the code-spread second data stream into second frequency, and second electrical-optical converter which converts the second data stream into second optical carrier of second optical signal having the predetermined optical wavelength.

Then, an optical coupler couples the first optical signal and the second optical signal for generating a multiplexed optical signal having the first optical carrier and the second optical carrier.

### BRIEF DESCRIPTION OF THE DRAWINGS

FIG. 1 is a schematic diagram disclosing a multiplexed optical transmission system as first.

FIG. 2 is a schematic diagram disclosing a conventional multiplexed optical transmission system.

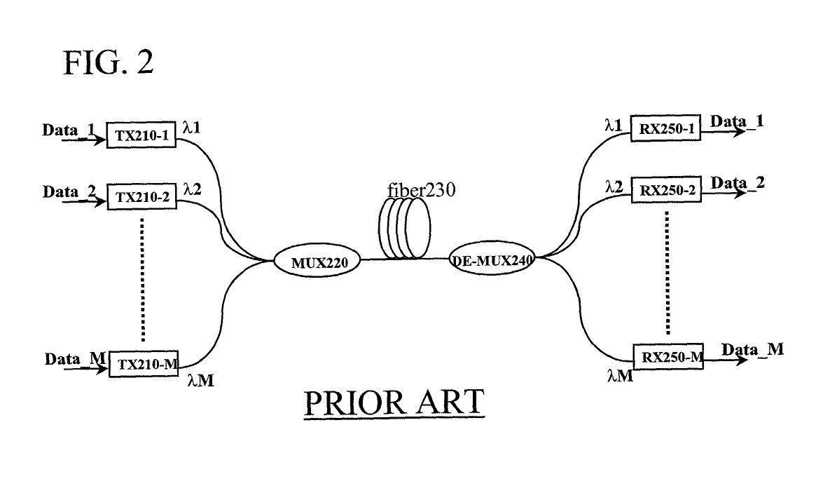

FIG. 3 is a block diagram disclosing optical transmitters 110_{—1}, . . . , 110_{—M} of the first embodiment.

FIG. 4 is a block diagram disclosing an optical receiver 140 of the first.

FIG. 5 is a schematic diagram showing the signal distribution states of the input data on each step of the transmitter side.

FIG. 6 is a diagram showing the signal distribution states of input data on the optical signal, which are outputted from the optical transmitters 110_{—1}, . . . , 110_{—M} of the first embodiment.

FIG. 7 is a schematic diagram showing a construction of a multiplexed optical transmission system of the second embodiment.

FIG. 8 is a block diagram showing a construction of the optical transmitter 710 of the second embodiment.

FIG. 9 is a block diagram showing a construction of the optical receiver 720 of the second embodiment.

FIG. 10 is a diagram showing the signal distribution states of input data on the optical signal, which are outputted from the optical transmission unit 711_{—1}, . . . , 711_{—M} of the second embodiment.

### DETAILED DESCRIPTION OF THE PREFERRED EMBODIMENTS

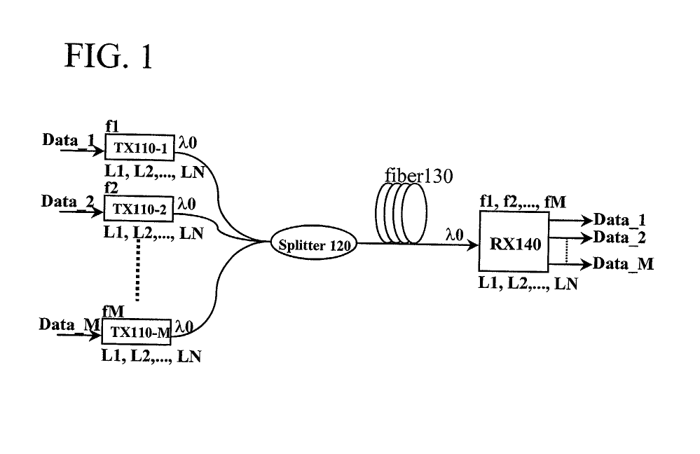

FIG. 1 shows a construction of first embodiment of the invention.

A multiplexed optical transmission system of the first embodiment is comprised of M optical transmitters (:TX) 110_{—1}, . . . , 110_{—M}, a beam splitter (:Splitter) 120, optical fiber transmission lines (:fiber)130, and an optical receiver (:RX) 140.

Each of the optical transmitters (:TX) 110_{—1}, . . . , 110_{—M} is supplied with data streams of the electrical signal Data_{—1}, . . . , Data_{—M} respectively.

The beam splitter 120 works as optical coupler and multiplexes optical signals outputted from the optical transmitters 110_{—1}, . . . , 110_{—M} respectively.

The optical fiber transmission lines 130 are connected to the beam splitter 120.

The optical receiver (:RX) 140 extracts the data stream of the electrical signal Data_{—1}, . . . , Data_{—M} from an optical signal inputted via the optical fiber transmission lines 130.

In FIG. 1, each of the optical transmitters 110_{—1}, . . . , 110_{—M} is an optical transmitter outputting an optical signal having fixed optical wavelength λ₀. And, the optical transmitters 110_{—1}, . . . , 110_{—M} uses spreading-codes L₁, . . . , L_{N} and frequencies f₁, . . . , f_{M} for multiplexing.

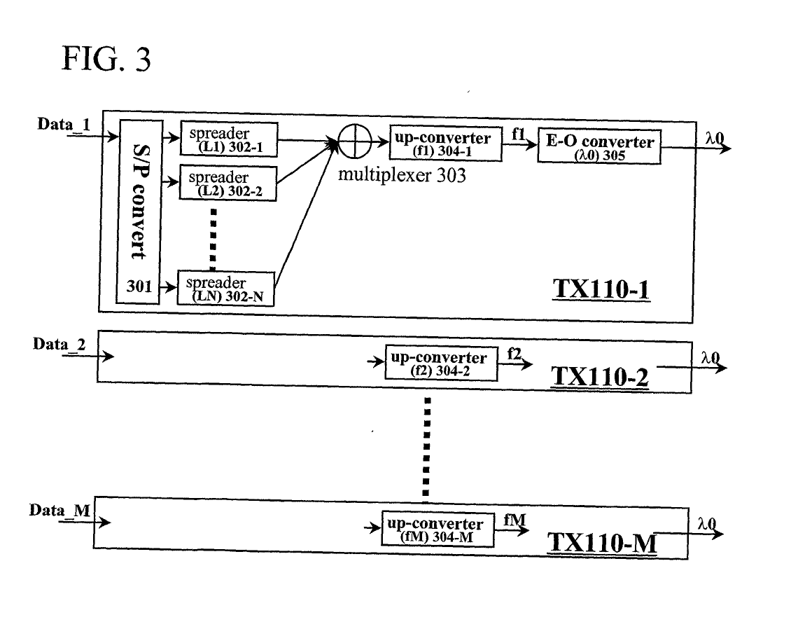

Detailed constructions of the optical transmitter 110_{—1}, . . . , 110_{—M} are shown in a block diagram of FIG. 3.

The optical transmitters 110_{—1}, . . . , 110_{—M} substantially have the same construction.

Therefore, only the optical transmitter 110_{—1} is explained detailed construction and the other optical transmitters 110_{—2}, . . . , 110_{—M} are explained only different parts from the optical transmitter 110_{—1}.

First, the construction of the optical transmitter 100_{—1} is explained as representation of the optical transmitters 110_{—1}, . . . , 110_{—M}.

The optical transmitter 110_{—1} is comprised of a data processing circuit (:S/P convert) 301, a spreader (L₁) 302_{—1}, . . . , a spreader (L_{N}) 302_{—N}, a multiplexer 303, an up-converter (f₁) 304_{—1}, and an electrical-optical converter (λ₀) 305.

When the data stream of the electrical signal Data_{—1} is inputted into the data processing circuit (:S/P convert) 301, the electrical signal Data_{—1} is serial-parallel converted and divided into N data streams of the electrical signal.

Each of the N data streams of the electrical signal is respectively inputted into the spreader (L₁) 302_{—1}, . . . , the spreader (L_{N}) 302_{—N}, which code-spread the inputted data stream by using the spreading-codes L₁, . . . , L_{N} respectively.

The code-spread N data streams of the electrical signal are multiplexed in the multiplier 303, and then, the multiplexed electrical signal is inputted in the up-converter (f₁) 304_{—1}, which is a frequency-converter.

In the up-converter (f₁) 304_{—1}, the multiplexed electrical signal is up-converted, namely frequency-converted as a multiplexed electrical signal having frequency of the f₁.

Then, the multiplexed electrical signal is inputted into the electrical-optical converter (λ₀) 305.

The electrical-optical converter (λ₀) 305 has an LD oscillator which radiates laser beam having the fixed optical wavelength λ₀, and by using direct modulation method or an external modulator, outputs an optical signal having optical wavelength λ₀ and superimposed the multiplexing signal as optical carrier.

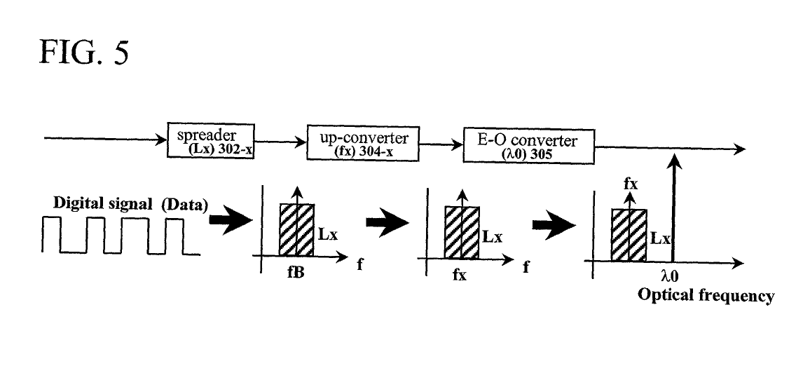

FIG. 5 is a schematic diagram showing the signal distribution states of the input data on each step of the transmitter side.

As it is shown in the diagram, at the spreader (Lₓ) 302_{—x}, a digital signal is code-spread based on spreading-code Lx in a band of intermediate frequency f_{B}. Then, at the up-converter (fₓ) 304_{—x}, the signal is converted into a code-spread signal based on the spreading-code Lₓ in a band of frequency fx.

After that, the code-spread signal is converted into a optical signal by the electrical-optical converter (λ₀) 305. Consequently, the digital data is included in an optical signal having optical wavelength λ₀ as distributing in a band of optical carrier fx.

Also in the optical transmitters 110_{—2}, . . . , 110_{—M}, which the data streams of the electrical signals Data_{—2}, . . . , Data_{—M} are inputted respectively, processing almost equivalent to the optical transmitter 110_{—1} is performed.

However, regarding the optical transmitters 110_{—2}, . . . , 110_{—M}, each component differs at the point of frequency-converting into multiplexed signals having frequency of the signal f₂, . . . , frequency of the signal f_{M} by using up-converter (f₂) 304_{—2}, . . . , up-converter (f_{M}) 304_{—M} respectively.

Then, it is as follows when the process of electrical-optical converting at each of the data streams of the electrical signal Data_{—1}, . . . , Data_{—M} is generalized.

Each of data stream Data_{—m} among the electrical data streams Data_{—1}, . . . , Data_{—M} is serial-parallel converted by the data processing circuit (:S/P convert) into m_{—1}_{^{st}}, . . . m_{—N}_{^{th}} data streams respectively, wherein M is an integer of 2 or more, m is an integer of 1≦m≦M, and N is an integer of 1 or more.

Then, each of m_{—n}_{^{th}} data stream among the m_{—1}_{^{st}}, . . . , m_{—N}_{^{th}} data streams is code-spread by spreader (Lₙ) having spreading-code Lₙ respectively, wherein n is an integer of 1≦n≦N.

After that, the m_{—1}_{^{st}}, .., m_{—N}_{^{th}} data streams are multiplexed by a multiplier, and converted frequency of the multiplexed data stream by up-converter (fₘ) into frequency fₘ.

Finally, at an electrical-optical converter (λ₀), the multiplexed data stream including the m_{—1}_{^{st}}, . . . , m_{—N}_{^{th}} data streams is superimposed on an optical signal having an optical wavelength λ₀ as optical carriers.

Consequently, each of the m_{—n}_{^{th}} data stream is converted into m_{—n}_{^{th}} optical carrier of m_{—n}_{^{th}} optical signal having the same optical wavelength λ₀.

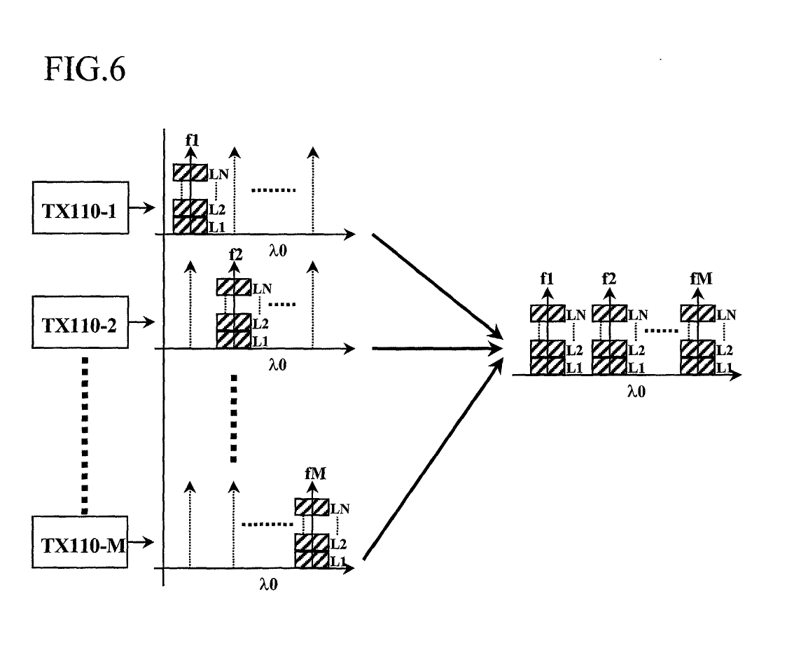

Furthermore, by using FIG. 6, signal distribution state of each optical signal outputted from the optical transmitters 110_{—1}, . . . , 110_{—M} is explained.

As previously explained using the FIG. 5, information about predetermined data stream is distributed on a band of predetermined optical carrier fₓ, which is included in an optical signal having the optical wavelength λ₀, as a state of code-spread by predetermined spreading-code Lₓ.

For example, in the case of an optical signal having an optical wavelength λ₀ which is outputted from the optical transmitter 110_{—1}, the data stream Data_{—1} is distributed on a band of optical carrier f₁, as states of code-spread by predetermined spreading-codes L₁, . . . , L_{N} respectively.

Similarly, in the case of an optical signal outputted from the optical transmitter 110_{—2}, the data stream Data_{—2} is distributed on a band of optical carrier f₂, as states of code-spread by predetermined spreading-codes L₁, . . . , L_{N} respectively.

Then, as the result of coupling them by the beam splitter 120, a multiplexed optical signal, which includes the data streams Data_{—1}, . . . , Data_{—M} distributed on bands of optical carriers f₁, . . . , f_{M} as states of code-spread by predetermined spreading-codes L₁, . . . , L_{N} respectively, is generated.

The multiplexed optical signal is inputted into an optical receiver RX via optical fiber transmission lines 130.

Based on the spreading-codes L₁, . . . , L_{N} and the frequencies f₁, . . . , f_{M}, the optical receiver RX de-multiplexes the data streams of the electrical signal Data_{—1}, . . . , Data_{—M} and outputs them.

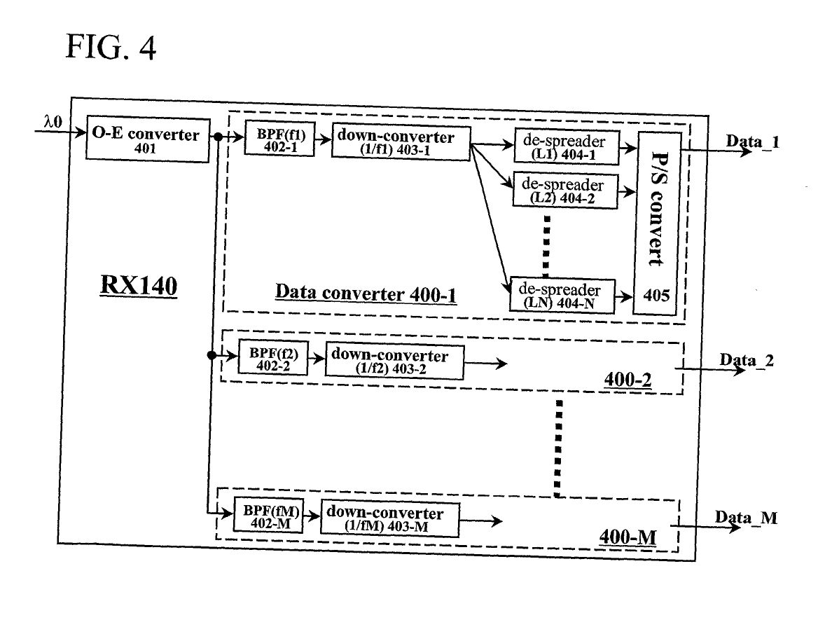

Detailed construction of an optical receiver (:RX) 140 is explained in FIG. 4 as a block diagram.

The optical receiver 140 comprises an optical-electrical converter 401, and data converters 400_{—1}, . . . , 400_{—M} connecting the optical-electrical converter 401 respectively.

In the FIG. 4, the data converters 400_{—1}, . . . , 400_{—M} substantially have the same construction.

Therefore, only the data converter 400_{—1} is explained detailed construction and the other data converters 400_{—2}, . . . , 400_{—M} are explained only different parts from the data converter 400_{—1}.

First, the construction of the data converter 400_{—1} is explained as representation of the data converters 400_{—1}, . . . , 400_{—M}.

The data converter 400_{—1} is comprised of a band pass filter (:BPF) (f₁) 402_{—1}, a down-converter (1/f₁) 403_{—1}, de-spreaders (L₁) 404_{—1}, . . . , de-spreaders (L_{N}) 404_{—N}, and a data processing circuit (:P/S convert) 405.

When the multiplexed optical signal λ₀ is inputted into the optical-electrical converter 401, the multiplexed optical signal λ₀ is converted into an electrical signal.

At this point, a optical intensity fluctuation of the multiplexed optical signal λ₀ corresponds to the multiplexed signal superimposed as the optical carriers.

Consequently, the optical-electrical converter 401 can easily convert the multiplexed optical signal into the multiplexed signal of an electrical signal.

Then, the electrical signal is inputted to the data converters 400_{—1}, . . . , 400_{—M} respectively.

In the data converter 400_{—1}, the inputted electrical signal is filtered by a band pass filter (f₁) 402_{—1}. As a result, elements of the frequency f₁ band are only extracted from the inputted electrical signal.

Then, the elements of the frequency f₁ band are frequency-converted into frequency 1/f₁ by a down-converter (1/f₁) 403_{—1}, or a frequency-converter.

The signal converted into the frequency 1/f₁ contains multiplexed N data streams which are code-spread at the optical transmitter 110_{—1} by the spreading-codes L₁, . . . , L_{N} respectively.

Each of the N data streams is de-spread by de-spreaders (L₁) 404_{—1}, . . . , (L_{N})404_{—N} using the spreading-codes L₁, . . . , L_{N} respectively.

Finally, the N data streams are parallel-serial converted by a data processing circuit (:P/S convert) 405. So, the data stream of the electrical signal Data_{—1}, which is inputted in the optical transmitter 110_{—1}, is reproduced.

In the reproducing process, signal distribution states of any steps are reverse process of the multiplexing process at the optical transmitter 110_{—1}, which has been explained by using the FIG. 5 previously. So, detailed explanation of the process is omitted.

Also in the data converters 400_{—2}, . . . , 400_{—M}, process of reproducing almost equivalent to the data converter 400_{—1} is performed.

However, regarding the data converters 400_{—2}, . . . , 400_{—M}, each component differs at the points of filtering the inputted electrical signal by band pass filters (f₂) 402_{—2}, . . . , (f_{M}) 402_{—M} for extracting elements of the frequency f₂, . . . , f_{M} bands respectively, and frequency-converting the elements of the frequency f₂, . . . , f_{M} bands into frequencies 1/f₂, . . . , 1/f_{M} by using down-converters (1/f₂)403_{—2}, . . . , (1/f_{M})403_{—M}, respectively.

Then, the data streams Data_{—2}, . . . , Data_{—M} are reproduced like the process at the data converter 400_{—1}.

According to the multiplexed optical transmission system of the first embodiment, the optical signal is modulated based on a spectrum-spread signal which is generated by code-division multiplexing.

Consequently, since narrow spectrum noises with high power density like beat noises between signal-wavelengths are not recognized as correlation codes, it does not make deterioration of transmission quality.

The optical transmitters 110_{—1}, . . . , 110_{—M} of the first embodiment output optical signals having identical optical wavelength.

Then, each of the data streams is code-spread by predetermined spreading-code and frequency-converted into predetermined frequency.

Thereafter, the data streams are superimposed in optical carriers of optical signals having the same wavelength, and are multiplexed.

So, the optical signals outputted from the optical transmitters 110_{—1}, . . . , 110_{—M} can be coupled by using inexpensive power coupler/splitter like the beam splitter 120.

Consequently, the embodiment realizes reducing a cost of transmission system.

Furthermore, selecting the spreading-codes of the code-spreading and the frequency of the frequency-converting as each of the data streams is assigned at least one of spreading-code or frequency different each other, “the number of spreading-codes x the number of frequencies” data streams can be multiplexing-transmitted by using one optical wavelength.

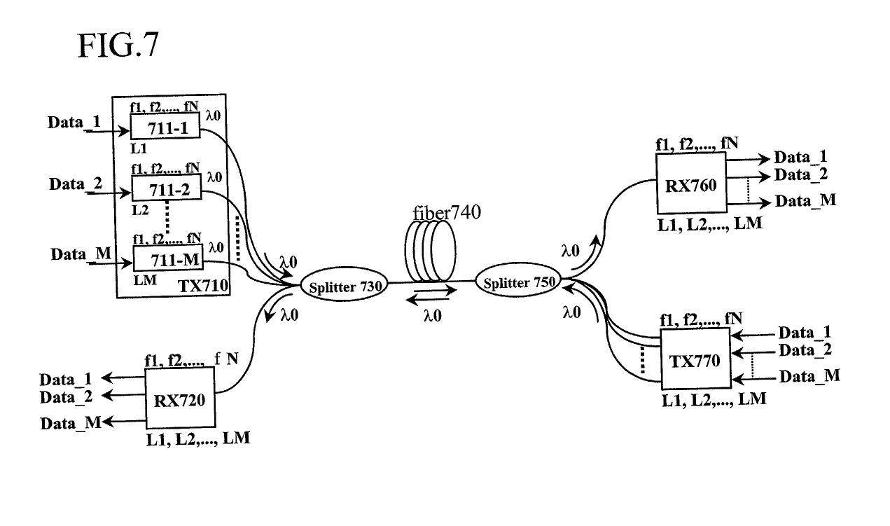

Then, a second embodiment of the invention will be explained by referring FIG. 7, which discloses a construction of the embodiment.

FIG. 7 is a schematic diagram showing a construction of a multiplexed optical transmission system comprising optical transmitters (:TX) 710 and 770, optical receivers (:RX) 720 and 760, a beam splitter (:Splitter) 730 and 750, and optical fiber transmission lines (:fiber) 740.

And, the system carries out bi-directional transmitting differently the first embodiment.

The optical transmitter 710 and the optical receiver 760 are used for signal transmission to the right side from the left side in the diagram, and the optical transmitter 770 and optical receiver 720 are used for signal transmission to the left side from the right side.

Both are substantially symmetrical construction. Therefore, we will explain only about the relations between the optical transmitter 710 and the optical receiver 760, and the explanation of the other side is omitted.

In FIG. 7, the optical transmitter 710 comprises optical transmission units 711_{—1}, . . . , 711_{—M}.

Each of the optical transmission units 711_{—1}, . . . , 711_{—M} outputs an optical signal having an optical wavelength λ₀, the transmitter 710 multiplexes signals by using frequencies of the signal f₁, . . . , f_{N} and spreading-codes L₁, . . . , L_{M}.

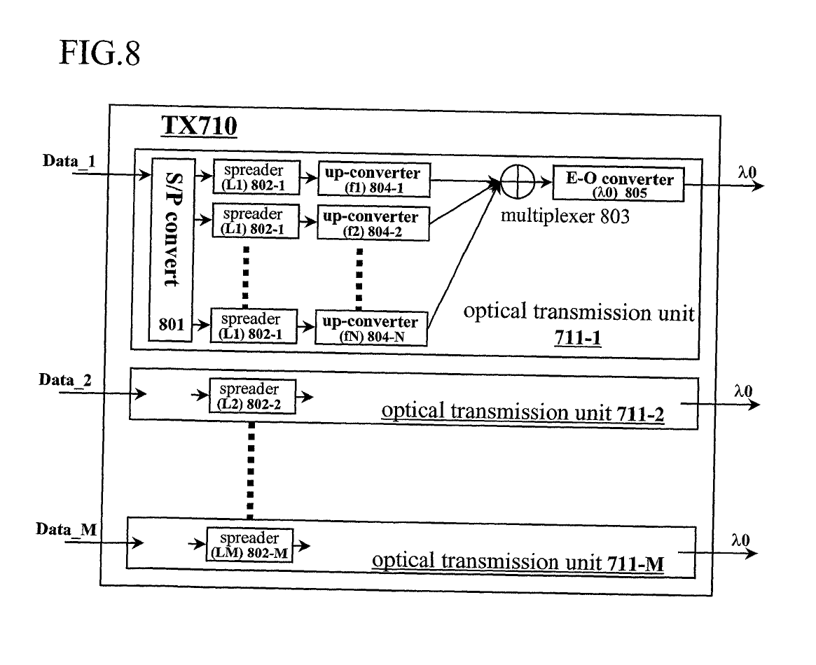

By using a block diagram of FIG. 8, detailed construction of the optical transmitter 710 will be explained. Incidentally, the optical transmission units 711_{—1}, . . . ,711_{—M} of the optical transmitter 710 are basically the identical construction. In the FIG. 8, only the construction of the optical transmission unit 711_{—1} is explained detailedly. Then, remaining optical transmission units 711_{—2}, . . . ,711_{—M} are only explained constructions difference from the optical transmission unit 711_{—1}, and the same constructions are omitted.

First, representing the optical transmission units 711_{—1}, . . . ,711_{—M}, a construction of the optical transmission unit 711_{—1} will be explained.

The optical transmission unit 711_{—1} comprises a data processing circuit (:S/P convert) 801, N spreaders (L₁) 802_{—1}, an up-converters (f₁) 804_{—1}, . . . ,(f_{N}) 804_{—N}, a multiplier 803, and electrical-optical converter (λ₀) 805.

When a data stream of electrical signal Data_{—1} is inputted into the data processing circuit (:S/P convert) 801, the stream is converted serial-parallel. As a result, the stream is divided into N different data streams of electrical signal.

Each of the N data streams is inputted into corresponding N spreaders (L₁) 802_{—1} respectively, which code-spread the data streams using a spread code L₁.

The code-spread N data streams are respectively inputted into the up-converters (f₁) 804_{—1}, . . . ,(f_{N}) 804_{—N} for frequency-converting, which up-convert frequencies of the code-spread N data streams into f₁, . . . ,f_{N} respectively.

The frequency-converted N data streams are multiplexed by the multiplier 803 and inputted into the electrical-optical converter (λ₀) 805 which generates an optical signal having an optical wavelength λ₀. Consequently, the multiplexed N data streams are superimposed on the optical signal as an optical carrier.

Also in the optical transmission units 711_{—2}, . . . , 711_{—M}, which the data streams of the electrical signals Data_{—2}, . . . , Data_{—M} are inputted respectively, processing almost equivalent to the optical transmission unit 711_{—1} is performed.

However, regarding the optical transmission units 711_{—2}, . . . , 711_{—M}, each component differs at the point of code-spreading by inputted into N spreaders (L₂) , . . . , (L_{M}) respectively.

Then, it is as follows when the process of electrical-optical converting at each of the data streams of the electrical signal Data_{—1}, . . . , Data_{—M} is generalized.

Each of data stream Data, among the electrical data streams Data_{—1}, . . . , Data_{—M} is serial-parallel converted by the data processing circuit (:S/P convert) into m_{—1}_{^{st}}, . . . m_{—N}_{^{th}} data streams respectively, wherein M is an integer of 2 or more, m is an integer of 1≦m≦M, and N is an integer of 1 or more.

Then, each of m_{—n}_{^{th}} data stream among the m_{—1}_{^{st}}, . . . , m_{—N}_{^{th}} data streams is code-spread by spreader (Lₘ) having spreading-code Lₘ respectively, wherein n is an integer of 1≦n≦N.

After that, the m_{—1}_{^{st}}, . . . , m_{—N}_{^{th}} data streams are multiplexed by a multiplier, and converted frequency of the multiplexed data stream by up-converter (fₙ) 804_{—n} into frequency fₙ.

Finally, at an electrical-optical converter (λ₀) 805, the multiplexed data stream including the m_{—1}_{^{st}}, . . . , m_{—N}_{^{th}} data streams is superimposed on an optical signal having an optical wavelength λ₀ as optical carriers.

Consequently, each of the m_{—n}_{^{th}} data stream is converted into m_{—n}_{^{th}} optical carrier of m_{—n}_{^{th}} optical signal having the same optical wavelength λ₀.

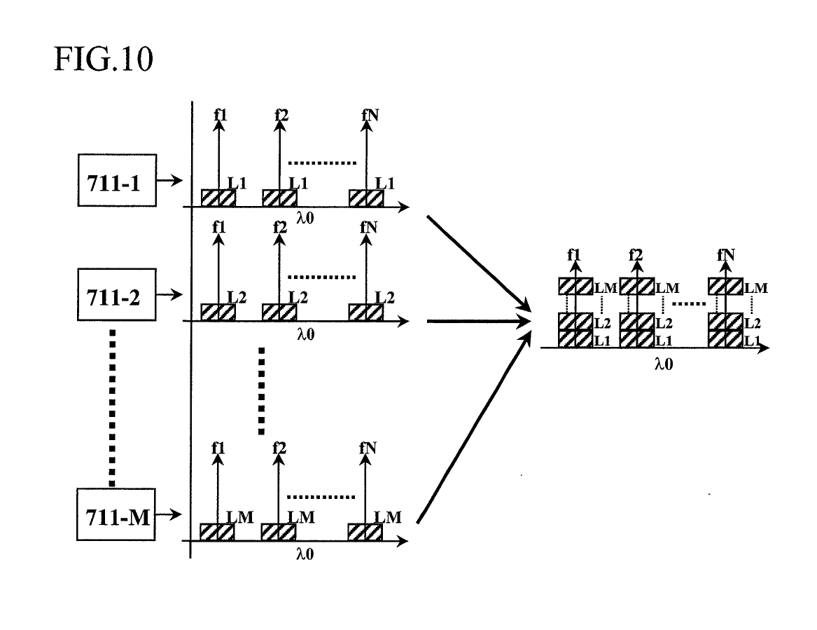

Furthermore, by using FIG. 10, signal distribution state of each optical signal outputted from the optical transmission units 711_{—1}, . . . , 711_{—M} is explained.

For example, in the case of an optical signal having an optical wavelength λ₀ which is outputted from the transmission unit 711_{—1}, the data stream Data_{—1} is distributed on bands of optical carriers f₁, . . . , f_{N} respectively, as state of code-spread by a spreading-code L₁.

Similarly, in the case of an optical signal outputted from the optical transmission unit 711_{—2}, the data stream Data_{—2} is distributed on bands of optical carriers f₁, . . . , f_{N} respectively, as state of code-spread by a spreading-code L₂.

Then, as the result of coupling them by the beam splitter 730, a multiplexed optical signal, which includes the data streams Data_{—1}, . . . , Data_{—M} distributed on bands of optical carriers f₁, . . . , f_{N} as states of code-spread by predetermined spreading-codes L₁, . . . , L_{M} respectively, is generated.

The multiplexed optical signal is inputted into an optical receiver 760 via optical fiber transmission lines 730 and a beam splitter 750.

Based on the spreading-codes L₁, . . . , L_{M} and the frequencies f₁, . . . , f_{N}, the optical receiver 760 de-multiplexes the data streams of the electrical signal Data_{—1}, . . . , Data_{—M} and outputs them.

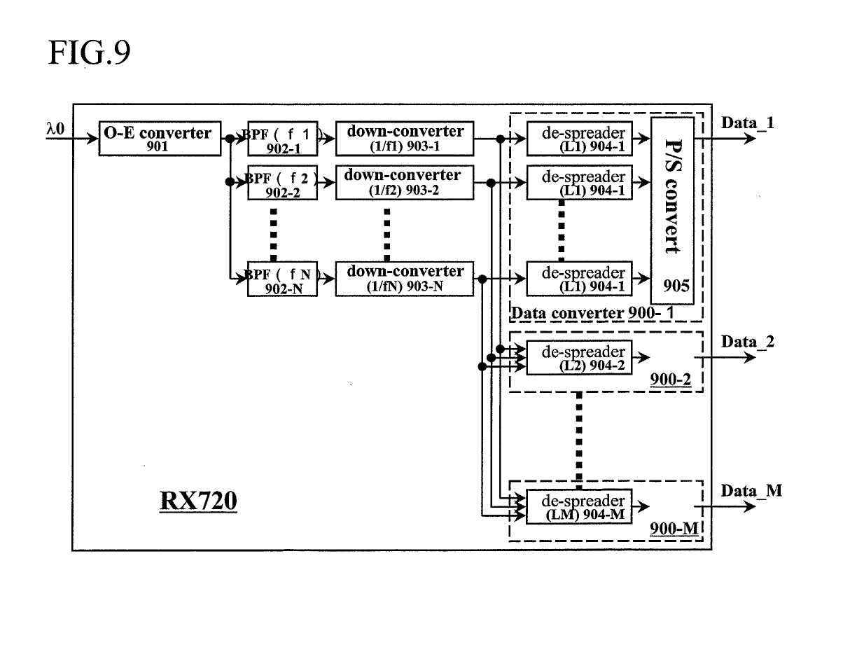

Detailed construction of an optical receiver 760 is explained in FIG. 9 as a block diagram.

The optical receiver 760 comprises an optical-electrical converter 901, band pass filters (:BPF) (f₁) 902_{—1}, . . . , (f_{N}) 902_{—N} connecting the optical-electrical converter 901 respectively, down-converters (1/f₁) 903_{—1}, . . . ,(1/f_{N}) 903_{—N} connecting each of the band pass filters (:BPF) (f₁) 902_{—1}, . . . , (f_{N}) 902_{—N} respectively, and data converters 900_{—1}, . . . , 900_{—M} connecting the down-converters (1/f₁) 903_{—1}, . . . ,(1/f_{N}) 903_{—N} reciprocally.

In the FIG. 9, the data converters 900_{—1}, . . . , 900_{—M} substantially have the same construction.

Therefore, only the data converter 900_{—1} is explained detailed construction and the other data converters 900_{—2}, . . . , 900_{—M} are explained only different parts from the data converter 900_{—1}.

First, the construction of the data converter 900_{—1} is explained as representation of the data converters 900_{—1}, . . . , 900_{—M}.

The data converter 900_{—1} is comprised of N de-spreaders (L₁) 904_{—1} arranged in parallel, and a data processing circuit (:P/S convert) 905 connecting the N de-spreaders (Li) 904_{—1}.

When the multiplexed optical signal λ₀ is inputted into the optical-electrical converter 901, the multiplexed optical signal λ₀ is converted into an electrical signal.

At this point, a optical intensity fluctuation of the multiplexed optical signal λ₀ corresponds to the multiplexed signal superimposed as the optical carriers.

Consequently, the optical-electrical converter 901 can easily convert the multiplexed optical signal into the multiplexed signal of an electrical signal.

Then, the electrical signal is inputted to the band pass filters (f₁) 902_{—1}, . . . , (f_{N}) 902_{—N} arranged in parallel, respectively.

And, each of elements of the frequency f₁, . . . , f_{N} bands is extracted by the band pass filters (f₁) 902_{—1}, . . . , (f_{N}) 902_{—N} respectively.

Then, each of the elements of the frequency f₁, . . . , f_{N} bands is frequency-converted into frequencies 1/f₁, . . . , 1/f_{N} by down-converters (1/f₁) 903_{—1}, . . . , (1/f_{N}) 903_{—N} respectively.

The signals converted into the frequencies 1/f₁, . . . , 1/f_{N} contain N data streams which are code-spread at the optical transmission unit 711_{—1} by the spreading-code L₁.

Therefore, in the data converter 900_{—1}, each of the N data streams is de-spread by the N de-spreaders (L₁) 904_{—1} using the spreading-code L₁ respectively.

Finally, the N data streams are parallel-serial converted by a data processing circuit (:P/S convert) 905. So, the data stream of the electrical signal Data_{—1}, which is inputted in the optical transmitter 710, is reproduced.

Also in the data converters 900_{—2}, . . . , 900_{—M}, process of reproducing almost equivalent to the data converter 900_{—1} is performed.

However, regarding the data converters 900_{—2}, . . . , 900_{—M}, each component differs at the points of de-spreading by de-spreaders (L₂) 904_{—2}, . . . , (L_{M}) 904_{—M} using the spreading-codes L₂, . . . , L_{M} respectively.

Then, the data streams Data_{—2}, . . . , Data_{—M} are reproduced like the process at the data converter 900_{—1}.

According to the multiplexed optical transmission system of the second embodiment, like the first embodiment, the optical signal is modulated based on a spectrum-spread signal which is generated by code-division multiplexing.

Consequently, since narrow spectrum noises with high power density like beat noises between signal-wavelengths are not recognized as correlation codes, it does not make deterioration of transmission quality.

In the case of conventional bi-directional optical transmission systems, in order to prevent interference between wavelengths, the systems need to use different wavelength for each direction.

Or when using the wavelength in both directions, in case one transmitter is used, transmitter of another side needs to be stopped.

Moreover, common coupler has directional characteristic. So, on conventional bi-directional optical transmission systems, each transmission direction is need couplers for optical transmitter and for optical receiver, respectively.

By contrast, because of the embodiment uses wide band for signal transmitting and code-division multiplexed signal superimposed on an optical signal. For this reason, since there is few influence of the interference, there is no necessity of preparing a special function like the conventional bi-directional optical transmission systems.

Moreover, the same as the first embodiment, the second embodiment uses optical signals using identical optical wavelength.

Then, each of the data streams is code-spread by predetermined spreading-code and frequency-converted into predetermined frequency.

Thereafter, the data streams are superimposed in optical carriers of optical signals having the same wavelength, and are multiplexed.

So, the optical signals can be coupled or separated by using inexpensive power coupler/splitter.

As shown in the FIG. 7, the optical transmitter 710 and the optical receiver 720 can share the beam splitter 730, and the optical transmitter 770 and the optical receiver 760 can share the beam splitter 750.

Consequently, the embodiment realizes reducing a cost of transmission system further.

In the first and second embodiments, the data processing circuit (:S/P convert) serial-parallel converts one data stream into N data streams. However, the invention does not necessarily need such serial-parallel converting.

As an intelligible example, in the above-mentioned constructions, the case of N=1 corresponds to multiplexing M data streams without serial-parallel converting.

Furthermore, according to inputting a respectively different data stream into a total of “M×N” spreaders prepared in the first, . . . , M^{th} optical transmitters 110_{—1}, . . . , 110_{—M}, the total of “M×N” data streams can be multiplexed.

Also by these cases, each data streams superimposed into the optical carrier differ in spreading-code and/or frequency of frequency-converting mutually.

Therefore, using predetermined filtering and de-spreading at the optical receiver can reproduce each of the data streams.

In addition, unlike the first embodiment, the second embodiment has the construction that the first, . . . , M^{th} data streams are collectively inputted into single optical transmitter, i.e., the optical transmitter 710 or 770. And, the optical transmission units 711_{—1}, . . . , 711_{—M} are explained as components of the single optical transmitter.

However, the second embodiment may change the optical transmission units 711_{—1}, . . . , 711_{—M} as individual optical transmitters.

Furthermore, the outputs of the optical transmitters don't have to be multiplexed at once.

Then, the outputs can be multiplexed selectively at couplers located in optional points of the optical transmission lines.

Similarly, the first and second embodiment have the construction that the first, . . . , M^{th} data streams are collectively outputted from single optical receiver, i.e., the optical receiver 140, 720 or 760. And, they may change the optical receivers as individual optical transmitters corresponding to the data streams.

Then, like the optical transmitters, the data streams can be de-multiplexed selectively at splitters located in optional points of the optical transmission lines.

The invention may be embodied in other specific forms without departing from the spirit or essential characteristics thereof.

The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for multiplexed optical transition, the method comprising the steps of:
code-spreading first data stream of electrical signal by first spreading-code, and converting a frequency of the code-spread first data stream into first frequency;
converting the first data stream into first optical carrier of first optical signal having a predetermined optical wavelength;
code-spreading second data stream of electrical signal by second spreading-code, and converting a frequency of the code-spread second data stream into second frequency;
converting the second data stream into second optical carrier of second optical signal having the predetermined optical wavelength; and
coupling the first optical signal and the second optical signal for generating a multiplexed optical signal having the first optical carrier and the second optical carrier.

2. The method according to claim 1, wherein the first spreading-code is different from the second spreading-code, or the first frequency is different from the second frequency.

3. A method for multiplexed optical transition, the method comprising the steps of:
serial-parallel converting each of m data stream among first, . . . M^{th} data streams of electrical signal into m_{—1}_{^{st}}, . . . m_{—N}_{^{th}} data streams respectively;
code-spreading each of m_{—n}_{^{th}} data stream among the m_{—1}_{^{st}}, . . . , m_{—N}_{^{th}} data streams by n^{th} spreading-code, and converting a frequency of the code-spread m_{—n}_{^{th}} data stream into m^{th} frequency respectively;
converting each of the m_{—n}_{^{th}} data stream into m_{—n}_{^{th}} optical carrier of m_{—n}_{^{th}} optical signal having the same optical wavelength respectively; and
coupling each of the m_{—n}_{^{th}} optical signal for generating a multiplexed optical signal having the m_{—n}_{^{th}} optical carrier,
wherein M is an integer of 2 or more, m is an integer of 1≦M≦N is an integer of 1 or more, and n is an integer of 1≦n≦N.

4. A method for multiplexed optical transition, the method comprising the steps of:
serial-parallel converting each of m data stream among first, . . . M^{th} data streams of electrical signal into m_{—1}_{^{th}}, . . . m_{—N}_{^{th}} data streams respectively;
code-spreading each of m_{—n}_{^{th}} data stream among the m_{—1}_{^{st}}, . . . , m_{—N}_{^{th}} data streams by m^{th} spreading-code, and converting a frequency of the code-spread m_{—n}_{^{th}} data stream into n^{th} frequency respectively;
converting each of the m_{—n}_{^{th}} data stream into m_{—n}_{^{th}} optical carrier of m_{—n}_{^{th}} optical signal having the same optical wavelength respectively; and
coupling each of the m_{—n}_{^{th}} optical signal for generating a multiplexed optical signal having the m_{—n}_{^{th}} optical carrier,
wherein M is an integer of 2 or more, m is an integer of 1≦m≦M, N is an integer of 1 or more, and n is an integer of 1≦n≦N.

5. A multiplexed optical transmitter comprising:
first spreader which code-spreads first data stream of electrical signal by first spreading-code;
first frequency-converter which converts a frequency of the code-spread first data stream into first frequency;
first electrical-optical converter which converts the first data stream into first optical carrier of first optical signal having a predetermined optical wavelength;
second spreader which code-spreads second data stream of electrical signal by second spreading-code;
second frequency-converter which converts a frequency of the code-spread second data stream into second frequency;
second electrical-optical converter which converts the second data stream into second optical carrier of second optical signal having the predetermined optical wavelength; and
an optical coupler which couples the first optical signal and the second optical signal for generating a multiplexed optical signal having the first optical carrier and the second optical carrier.

6. The multiplexed optical transmitter according to claim 5, wherein the first spreading-code is different from the second spreading-code, or the first frequency is different from the second frequency.
